(19) United States
(12) Patent Application Publication
(10) Pub. No.: US 2026/0059072 A1
(43) Pub. Date: Feb. 26, 2026

(54) METHOD FOR CONTROLLING SPEAKING TIME OF MEETING PARTICIPANTS AND SYSTEM FOR THE SAME

(71) Applicant: Joble Inc., Palo Alto, CA (US)

(72) Inventor: Nelson Tosin AJULO, Rotterdam (NL)

(21) Appl. No.: 18/811,220

(22) Filed: Aug. 21, 2024

(51) Int. Cl. H04N 7/15; G06F 3/16

(52) U.S. Cl. CPC H04N 7/15; G06F 3/165

(57) ABSTRACT

This disclosure generally relates to data processing, and more particularly, to a method and system for monitoring a speaking time of meeting participants during a meeting, e.g. with the aim of increasing a meeting efficiency. According to an aspect of the present disclosure method for monitoring a speaking time of participants during a meeting is disclosed wherein use is made of a processor and a database. In another aspect of the disclosure, a system for monitoring a speaking time of participants during a meeting is disclosed, the system comprising a processor and a database operatively connected to the database.

### TECHNICAL FIELD

This disclosure generally relates to data processing, and more particularly, to a method and system for monitoring a speaking time of meeting participants during a meeting, e.g. with the aim of increasing a meeting efficiency.

### BACKGROUND

The developments described in this section are known to the inventors. However, unless otherwise indicated, it should not be assumed that an of the developments described herein qualify as prior art merely by virtue of their inclusion in this section, or that these developments are known to a persons of ordinary skill in the art.

U.S. Pat. No. 11,489,685B2 describes various methods and system for generating a meeting efficiency index. A receiver receives a request from an organizer to organize a meeting. A processor, operatively connected to the receiver via a communication network, accesses a database to obtain management data, organizational data, and psychological data corresponding to the requested meeting in response to the received request. The processor applies an algorithm to combine the obtained management data, organizational data, and the psychological data to determine a meeting efficiency index for the requested meeting. The meeting index is displayed together with a calendar item and input is received whether to accept or reject the meeting based on the index.

### SUMMARY

The present disclose, through one or more of its various aspects, embodiments, and/or specific features or subcomponents may provide, among others, various systems and/or methods for monitoring a speaking time of participants during a meeting.

According to an aspect of the present disclosure method for monitoring a speaking time of participants during a meeting is disclosed wherein use is made of a processor and a database, wherein the method comprises:
receiving a participant list of multiple participants for the meeting;
receiving an agenda list of agenda items of a meeting agenda for the meeting;
obtaining, from the database, for each participant on the participant list and each agenda item on the agenda list, a competence level value, which competence level value is representative of a competence level of the associated participant at the associated agenda item;
applying an algorithm to determine for each participant and each agenda item, an associated participant speaking time, which participant speaking time is proportional to the competence level value of the associated participant at the associated agenda item divided by a total sum of competence level values for all participants at the associated agenda item;
monitoring an actual speaking time of each participant during a current agenda item, which current agenda item is one of the agenda items on the agenda list;
comparing the actual speaking time of each participant during the current agenda item to the associated participant speaking times during the current agenda item; and
outputting an output signal representative of the actual speaking time of one of the participants exceeding the associated speaking time when the actual speaking time of one of the participants exceeds the associated participant speaking time.

In a further aspect, an image representative of the output signal is displayed in conjunction with the agenda item during the meeting when the actual speaking time of the participant exceeds the associated speaking time.

In a further aspect, the image representative of the output signal indicates the participant whose actual speaking time exceeds the participant speaking time.

In a further aspect, the output signal is an audio signal.

In a further aspect, the output signal further indicates the participant whose actual speaking time exceeds the participant speaking time.

In a further aspect, the meeting is a virtual meeting.

In a further aspect, the output signal causes an audio volume of the participant whose actual speaking time exceeds the participant speaking time to be reduced or muted.

In a further aspect, the output signal causes at least one of a color scheme or image size of an image of the participant in the meeting to change.

In a further aspect, the output signal is provided to a host of the meeting.

In a further aspect, the competence level value of each participant at each agenda item is one of a number of discrete values representative of a competence level bracket of the associated participant at the associated agenda item.

In a further aspect, the agenda list further comprises for each agenda item an agenda item time which indicates a length of time the associated agenda item lasts.

In a further aspect, the participant speaking time during an agenda item is further proportional to the associated agenda item time.

In a further aspect, wherein the agenda item time is based on a total meeting time of the meeting.

In another aspect of the disclosure, a system for monitoring a speaking time of participants during a meeting is disclosed, the system comprising a processor and a database operatively connected to the database, wherein the processor is configured to:
receive a participant list of multiple participants for the meeting;
receive an agenda list of agenda items of a meeting agenda for the meeting;
obtain, from the database, for each participant on the participant list and each agenda item on the agenda list, a competence level value, which competence level value is representative of a competence level of the associated participant at the associated agenda item;
apply an algorithm to determine for each participant and each agenda item, an associated participant speaking time, which participant speaking time is proportional to the competence level value of the associated participant at the associated agenda item divided by a total sum of competence level values for all participants at the associated agenda item;
monitor an actual speaking time of each participant during a current agenda item, which current agenda item is one of the agenda items on the agenda list;
compare the actual speaking time of each participant during the current agenda item to the associated participant speaking times during the current agenda item; and
output an output signal representative of the actual speaking time of one of the participants exceeding the associated speaking time when the actual speaking time of one of the participants exceeds the associated participant speaking time.

In a further aspect, the system further comprises a display for displaying an image representative of the output signal in conjunction with the agenda item during the meeting when the actual speaking time of the participant exceeds the associated speaking time.

In a further aspect, wherein the image representative of the output signal indicates the participant whose actual speaking time exceeds the participant speaking time.

In a further aspect, the system further comprises a speaker for outputting the output signal as an audio signal.

In a further aspect, the output signal further indicates the participant whose actual speaking time exceeds the participant speaking time.

In a further aspect, wherein the meeting is a virtual meeting.

In a further aspect, the output signal causes the processor to reduce or mute an audio volume of the participant whose actual speaking time exceeds the participant speaking time.

In a further aspect, the output signal causes the processor to change at least one of a color scheme or image size of an image of the participant.

In a further aspect, the output signal is provided to a host of the meeting.

In a further aspect, the competence level value of each participant at each agenda item is one of a number of discrete values representative of a competence level bracket of the associated participant at the associated agenda item.

In a further aspect, the agenda list further comprises for each agenda item an agenda item time which indicates a length of time the associated agenda item lasts.

In a further aspect, the participant speaking time during an agenda item is further proportional to the associated agenda item time.

In a further aspect, the agenda item time is based on a total meeting time of the meeting.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 shows a chart of an embodiment of the method of the invention, and

FIG. 2 shows a depiction of a system of an embodiment of the invention.

### DETAILED DESCRIPTION

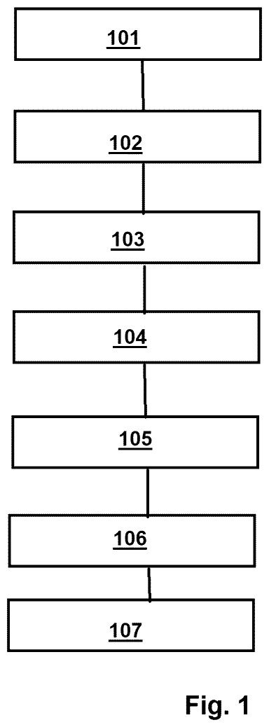

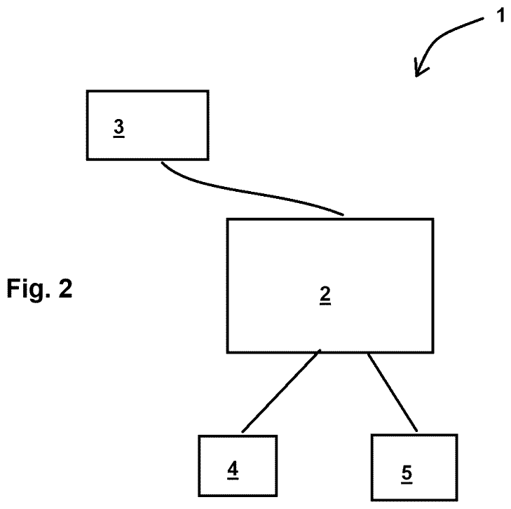

FIG. 1 shows a flowchart of an embodiment of the method of the invention. The method make use of a system 1 comprising a processor 2 and a database 3 as shown in FIG. 2.

The method of the invention allows for monitoring a speaking time of participants during a meeting to increase an efficiency of the meeting. The meeting may be said to be more efficient if during a same time period a larger number of goals of the meeting are met.

Generally, participants of the meeting will have different qualifications. For example, some participants may have more experience or may be more qualified than other participants, e.g. depending on the subject being discussed. This makes it so that the efficiency of the meeting depends on which participants contribute to which agenda item. For example, if a finance expert contributes more to a meeting than an computer scientist, than the meeting may be more efficient if the contents of the meeting are related to finance. The invention uses this insight to quantify a speaking time of each participant based on the participant's competence level in relation to the different agenda items. For example, agenda items may be related to different competencies, e.g. different specializations, based on the contents to be discussed during the agenda items.

The invention relates to a method for monitoring a speaking time of participants during a meeting wherein use is made of a system 1 comprising a processor 2 and a database 3. The method comprises receiving 101 a participant list of multiple participants for the meeting. It may be possible that the meeting has more participants than the number of participants on the participant list. For example, in case where some participants are silent or observing participants which are not expected or supposed to contribute to the meeting. Thus, the participant list is not necessarily an exhaustive list of participants for the meeting. The participant list may be received by the processor 2. The participant list may be received based on a meeting invite, and subsequent accepting thereof by the participants, send out by an organizer. The participant list may also be provided to the processor 2 by the host directly. The method further comprises receiving 102 an agenda list of agenda items of a meeting agenda for the meeting. The meeting will generally have an agenda listing the talking points for the meeting. As for the participant list, the agenda list does not necessarily include all agenda items of the meeting. For example, the opening and/or closing of the meeting may not be present in the agenda list because these items do not require the use of the invention. The agenda list may also comprise, for each agenda item thereon, one or more related competencies that are relevant for that particular agenda item. The related competencies may also be obtained implicitly, e.g. based on a name of the agenda item or a subject of the agenda item. The related competencies may also be provided separately, e.g. by the host of the meeting. Each agenda item may have one or more related competencies.

The method then comprises obtaining 103, from the database 3, for each participant on the participant list and each agenda item on the agenda list, a competence level value, which competence level value is representative of a competence level of the associated participant at the associated agenda item. For example, the competence level may be a competence level based on competencies of the participant in light of the agenda item. The competence level may be based on multiple competencies. The competence level value may be a numerical value between two boundary values, e.g. 0 and 10. The competence level value may also be a discrete value, e.g. based on a bracketed system. For example, participants may be divided into multiple, e.g. 3 brackets for each competence level associated with the agenda items, wherein a higher bracket indicates a higher level of competence. The competence level value may be a weighted average.

The database 3 may be obtained based on a background of the participants. For example, education and relative experience of the participants may allow to generally assign certain competencies or competence levels to the participants which may be provided to the database 3.

The method further comprises applying 104 an algorithm to determine for each participant and each agenda item, an associated participant speaking time, which participant speaking time is proportional to the competence level value of the associated participant at the associated agenda item divided by a total sum of competence level values for all participants at the associated agenda item. The participant speaking time represents, for the associated agenda item and associated participant, an amount of time that the participant should be speaking, e.g. contributing to, during the agenda item to obtain a more efficient meeting. If a less competent participant uses too much speaking time during an agenda item than the meeting will be less efficient. For example, in order to compensate for a less competent participant using too much time during an agenda item, the meeting length may have to be increased.

The actual speaking time of each participant is monitored 105, e.g. using a microphone, during a current agenda item, which current agenda item is one of the agenda items on the agenda list. For example, the processor 2 may monitor 105 the actual speaking time of each participant using a microphone and voice recognition software.

The method further comprises comparing 106 the actual speaking time of each participant during the current agenda item to the associated participant speaking times during the current agenda item. The processor 2 may compare the actual speaking time of each participant during the current agenda item real time. For example, when one of the participants is speaking, the associated participant speaking time is increased as time passes. Once the participant speaking time exceeds the participant speaking time of the associated participant than the output signal may be provided.

The method further comprise outputting 107 an output signal representative of the actual speaking time of one of the participants exceeding the associated speaking time when the actual speaking time of one of the participants exceeds the associated participant speaking time. The output signal may be an audio signal, such as a beep, or a visual signal. The output signal may be provided to each participant, the host, and/or the associated participant. The output signal may cause a microphone of the associated participant to be muted or an audio volume thereof to be reduced. During a virtual meeting, the output signal may also cause an image, e.g. a video image, of the associated participant to change, e.g. in color scheme and/or size, to indicate that the actual speaking time exceeds the participant speaking time.

In embodiments, an image representative of the output signal is displayed in conjunction with the agenda item during the meeting when the actual speaking time of the participant exceeds the associated speaking time. For example, the system 1 of the invention may comprise a display 3 that allows to display the agenda item and output signal. The image representative of the output signal may indicate to the participant whose actual speaking time exceeds the participant speaking time to stop speaking.

The output signal may also be an audio signal e.g. provided by a speaker 4. For example, the output signal may indicate to the participant whose actual speaking time exceeds the participant speaking time to stop speaking. For example, during a virtual meeting, the audio signal may be provided only to the associated participant and/or the host.

For example, the competence level value of each participant at each agenda item may be one of a number of discrete values representative of a competence level bracket of the associated participant at the associated agenda item. For example, three brackets may be provided with values 1, 2 and 3 and for each agenda item each participant may be associated with one of the brackets, thus associating a competence level value for each participant to the agenda item.

In embodiments, the agenda list further comprises for each agenda item an agenda item time which indicates a length of time the associated agenda item lasts. This allows for example that the participant speaking time during an agenda item is further proportional to the associated agenda item time. The agenda item time may be based on a total meeting time of the meeting.

1-26. (canceled)

27. A method for monitoring a speaking time of participants during a meeting wherein use is made of a processor and a database, wherein the method comprises:
receiving a participant list of multiple participants for the meeting;
receiving an agenda list of agenda items of a meeting agenda for the meeting;
obtaining, from the database, for each participant on the participant list and each agenda item on the agenda list, a competence level value, which competence level value is representative of a competence level of the associated participant at the associated agenda item;
applying an algorithm to determine for each participant and each agenda item, an associated participant speaking time, which participant speaking time is proportional to the competence level value of the associated participant at the associated agenda item divided by a total sum of competence level values for all participants at the associated agenda item;
monitoring an actual speaking time of each participant during a current agenda item, which current agenda item is one of the agenda items on the agenda list;
comparing the actual speaking time of each participant during the current agenda item to the associated participant speaking times during the current agenda item; and
outputting an output signal representative of the actual speaking time of one of the participants exceeding the associated speaking time when the actual speaking time of one of the participants exceeds the associated participant speaking time.

28. The method according to claim 27, wherein an image representative of the output signal is displayed in conjunction with the agenda item during the meeting when the actual speaking time of the participant exceeds the associated speaking time.

29. The method according to claim 28, wherein the image representative of the output signal indicates the participant whose actual speaking time exceeds the participant speaking time.

30. The method according to claim 27, wherein the output signal is an audio signal.

31. The method according to claim 30, wherein the output signal further indicates the participant whose actual speaking time exceeds the participant speaking time.

32. The method according to claim 27, wherein the meeting is a virtual meeting.

33. The method according to claim 32, wherein the output signal causes an audio volume of the participant whose actual speaking time exceeds the participant speaking time to be reduced or muted.

34. The method according to claim 32, wherein the output signal causes at least one of a color scheme or image size of an image of the participant in the meeting to change.

35. The method according to claim 27, wherein the output signal is provided to a host of the meeting.

36. The method according to claim 27, wherein the competence level value of each participant at each agenda item is one of a number of discrete values representative of a competence level bracket of the associated participant at the associated agenda item.

37. A system for monitoring a speaking time of participants during a meeting, the system comprising a processor and a database operatively connected to the database, wherein the processor is configured to:
receive a participant list of multiple participants for the meeting;
receive an agenda list of agenda items of a meeting agenda for the meeting;
obtain, from the database, for each participant on the participant list and each agenda item on the agenda list, a competence level value, which competence level value is representative of a competence level of the associated participant at the associated agenda item;
apply an algorithm to determine for each participant and each agenda item, an associated participant speaking time, which participant speaking time is proportional to the competence level value of the associated participant at the associated agenda item divided by a total sum of competence level values for all participants at the associated agenda item;
monitor an actual speaking time of each participant during a current agenda item, which current agenda item is one of the agenda items on the agenda list;
compare the actual speaking time of each participant during the current agenda item to the associated participant speaking times during the current agenda item; and
output an output signal representative of the actual speaking time of one of the participants exceeding the associated speaking time when the actual speaking time of one of the participants exceeds the associated participant speaking time.

38. The system according to claim 37, wherein the system further comprises a display for displaying an image representative of the output signal in conjunction with the agenda item during the meeting when the actual speaking time of the participant exceeds the associated speaking time.

39. The system according to claim 38, wherein the image representative of the output signal indicates the participant whose actual speaking time exceeds the participant speaking time.

40. The system according to claim 37, further comprising a speaker for outputting the output signal as an audio signal.

41. The system according to claim 40, wherein the output signal further indicates the participant whose actual speaking time exceeds the participant speaking time.

42. The system according to claim 37, wherein the meeting is a virtual meeting.

43. The system according to claim 42, wherein the output signal causes the processor to reduce or mute an audio volume of the participant whose actual speaking time exceeds the participant speaking time.

44. The system according to claim 42, wherein the output signal causes the processor to change at least one of a color scheme or image size of an image of the participant.

45. The system according to claim 37, wherein the output signal is provided to a host of the meeting.

46. The system according to claim 37, wherein the competence level value of each participant at each agenda item is one of a number of discrete values representative of a competence level bracket of the associated participant at the associated agenda item.
